(19) United States
(12) Patent Application Publication
(10) Pub. No.: US 2026/0365529 A1
(43) Pub. Date: Nov. 19, 2026

(54) METHOD FOR OPERATING AMMONIA SYNTHESIS AT PARTIAL LOAD AND PARTIAL-LOAD-CAPABLE AMMONIA SYNTHESIS

(71) Applicants: Linde GmbH, Pullach (DE); TECHNISCHE UNIVERSITÄT MÜNCHEN, München (DE)

(72) Inventors: Michael REINKE, Pullach (DE); Harald KLEIN, München (DE); Josef SCHWARZHUBER, Pullach (DE); Steffen FAHR, München (DE)

(21) Appl. No.: 19/121,020

(22) PCT Filed: Oct. 18, 2023
(86) PCT No.: PCT/EP2023/025437

§ 371 Date: Apr. 14, 2025

(30) Foreign Application Priority Data
Oct. 19, 2022 (EP) 22020497.8

(51) Int. Cl. C01C 1/04; B01J 8/04

(52) U.S. Cl. CPC C01C 1/0417; B01J 8/0492; B01J 8/0496; C01C 1/0452; C01C 1/047; B01J 2208/00212

(57) ABSTRACT

A method for the synthesis of ammonia, in which a gas mixture (make-up gas) comprising hydrogen and nitrogen is provided in a first operating mode with a flow rate that is above a threshold value and in a second operating mode with a flow rate that is below this threshold value in order to form an ammonia synthesis gas, which is reacted in an ammonia reactor in at least one first catalyst bed and in a second catalyst bed, connected to the first catalyst bed, to form a synthesis product containing ammonia, wherein in a cooling device arranged between the first and the second catalyst bed, non-reacted ammonia synthesis gas is used as a cooling agent in order to reduce the temperature of an ammonia synthesis gas partially reacted in the first catalyst bed before it is forwarded to the second catalyst bed.

The invention relates to a method for the synthesis of ammonia, in which a gas mixture (make-up gas) comprising hydrogen and nitrogen is provided in a first operating mode with a flow rate that is above a threshold value and in a second operating mode with a flow rate that is below this threshold value in order to form an ammonia synthesis gas, which is reacted in an ammonia reactor in at least one first catalyst bed and in a second catalyst bed, connected to the first catalyst bed, to form a synthesis product containing ammonia, wherein in a cooling device arranged between the first and the second catalyst bed, non-reacted ammonia synthesis gas is used as a cooling agent in order to reduce the temperature of an ammonia synthesis gas partially reacted in the first catalyst bed before it is forwarded to the second catalyst bed, wherein in the second operating mode, the higher the flow rate of the provided make-up gas, the greater the reduction in temperature of the partially reacted ammonia synthesis gas.

Ammonia is one of the most widely produced chemicals in the world. It is primarily used as a raw material for the production of fertilizers, but is also becoming increasingly important as an energy source and hydrogen storage means. On an industrial scale, it is synthesized almost exclusively from nitrogen and hydrogen using the Haber-Bosch process.

In the Haber-Bosch process, an ammonia synthesis gas, consisting mainly of hydrogen and nitrogen in which the two substances are present in a stoichiometric ratio of 3:1 for the synthesis of ammonia, is supplied to an ammonia reactor at a pressure of between 80 and 300 bar and a temperature between 300 and 450 °C in order to be reacted with formation of ammonia with catalytic support in an exothermic reaction. However, thermodynamic limitations render the reaction incomplete so that a synthesis product results that contains considerable amounts of hydrogen and nitrogen in addition to ammonia. The synthesis product leaves the ammonia reactor at a temperature between 400 and 450 °C, and is subsequently cooled in a series of heat exchangers to separate ammonia by condensation and obtain a recycle gas consisting largely of hydrogen and nitrogen and containing residues of ammonia that has not been condensed out, which is recycled to increase the ammonia yield in a synthesis cycle to the ammonia reactor, and in the process is mixed with a make-up gas comprising hydrogen and nitrogen to form the ammonia synthesis gas.

Ammonia reactors are usually designed as adiabatic multi-bed reactors that comprise at least two fluidically interconnected catalyst beds through which ammonia synthesis gas can flow in series, which during the process is reacted step by step into the synthesis product. A cooling device is arranged after the first and before each subsequent catalyst bed, via which the reaction heat is removed from the gas mixture obtained by reaction in the upstream catalyst bed in order to pass it on, cooled down, for further reaction into the downstream catalyst bed. The cooling agent used in such an intermediate cooling serves as non-reacted ammonia synthesis gas to be heated. Depending on whether the heat can be transferred directly or indirectly to the ammonia synthesis gas, they are referred to in professional circles as adiabatic quench cooling or AQC reactors, or adiabatic indirect cooling or AIC reactors.

The hydrogen required to form the make-up gas is still predominantly obtained from hydrocarbons which are reformed in this context into a hydrogen-rich synthesis gas with the production of carbon dioxide. The climate-damaging carbon dioxide is separated and either released into the atmosphere or disposed of through sequestration at great financial and equipment expense.

In order to overcome these disadvantages, increased efforts have recently been made to produce hydrogen without carbon dioxide, for example by electrochemical decomposition of water using an electrolyzer, and to use it to form the make-up gas. The electricity required on the whole for the ammonia production is obtained here directly from renewable sources such as wind or solar power plants, or as surplus electricity from the public grid, which is why it is not available with constant power. Since the operation of the electrolyzer and any air separator used for nitrogen production can be adapted relatively easily and quickly to fluctuating conditions, and the production quantities of hydrogen and nitrogen are, to a first approximation, proportional to the electrical power, the flow rates of hydrogen produced in the electrolyzer and nitrogen produced in the air separator vary with the amount of available electricity. Accordingly, the flow rates of the make-up gas and ammonia synthesis gas often reach less than half of the values that are required for full-load operation of ammonia synthesis over longer periods.

In contrast to the electrolyzer and an air separator that may be used for nitrogen production, the ammonia reactor and the synthesis cycle can only be adapted very slowly and to a limited extent to fluctuating operating conditions. A reduction in the amount of supplied make-up gas leads to a reduction in the amount of material in the synthesis cycle or the material flow circulating in the synthesis cycle. This in turn results in reduced pressure in the ammonia reactor and the synthesis circuit. Excessive and frequent pressure reduction leads to mechanical stress on the reactor and its associated plant components, which can only be addressed with high investments. If the suppliable amount of ammonia synthesis gas falls below a minimum value which is usually 30% of the value at full load, production must be interrupted and the ammonia reactor shut down.

In order to avoid shutting down the ammonia reactor, patent application WO2012/037571A2, for example, proposes storing hydrogen and nitrogen in buffer tanks during periods of excess electricity, when the electrolyzer produces more hydrogen and the air separator produces more nitrogen than can be consumed in the ammonia reactor, and using them during periods of power shortage to produce make-up gas with a flow rate above the minimum value. However, in order to bridge long-lasting periods of power shortages, the buffer tanks must be correspondingly large and expensive.

Another method is disclosed in EP3426601B1. In this case, an AQC ammonia reactor with at least a first and a second catalyst bed is used in which, at times when make-up gas is provided with a flow rate lying above a threshold value, a first partial flow of the available ammonia synthesis gas is fed to the first catalyst bed, and the gas mixture that is leaving the first catalyst bed is fed to the second catalyst bed after direct intermediate cooling in which a second partial flow of the available ammonia synthesis gas (quench volume flow) serves as a cooling agent. If the make-up gas is available at a flow rate below the threshold value, the ratio of the first to the second partial flow is increased so that the volume flow in the first catalyst bed is reduced disproportionately. Due to the reduced quench volume flow, the reaction in the second catalyst bed decreases so that the amount of ammonia synthesis gas decreases less than that of the make-up gas, thus maintaining a higher pressure in the ammonia reactor. In addition, this measure limits the temperature increase in the first catalyst bed. In downstream catalyst beds, the reaction is lower due to temperature and partial pressure so that the temperature rise is also reduced in these zones despite the lower quench volume flow.

As a comparative study (Comparison between three types of ammonia synthesis reactor configurations in terms of cooling methods, Mohammad Hasan Khademi and Reyhaneh Sadat Sabbaghi, Chemical Engineering Research and Design, Volume 128, December 2017, pages 306-317) revealed which examined three reactor types suitable for ammonia synthesis, AQC reactors are the least suitable for this task because the cooling method implemented in them is the least efficient.

The object of the present invention is therefore that of providing a method and an apparatus of the generic type by means of which it is possible to produce ammonia more efficiently than in the prior art.

The stated object is achieved according to the invention in terms of the method in that the cooling of the ammonia synthesis gas partially reacted in the first catalyst bed is carried out in indirect heat exchange against provided ammonia synthesis gas.

The provided ammonia synthesis gas can be reacted into the synthesis product in the ammonia reactor in more than two catalyst beds passed through in series, wherein a cooling device is arranged between each two immediately adjacent catalyst beds, in which provided, non-reacted ammonia synthesis gas serves as a cooling agent in order to cool the ammonia synthesis gas partially reacted in one catalyst bed in indirect heat exchange before it is forwarded to the following catalyst bed. Preferably, the provided ammonia synthesis gas is reacted into the synthesis product in three catalyst beds passed through in series, between each of which a cooling device is arranged.

In order to be able to introduce it into the first catalyst bed at a temperature between 300 and 450 °C, preferably between 330 and 430 °C, in the first operating mode, at least a part of the ammonia synthesis gas supplied to the ammonia reactor is used as a cooling agent in the cooling device(s) and is heated exclusively against partially reacted ammonia synthesis gas. If the heating takes place in two or more cooling devices, this part of the ammonia synthesis gas is preferably passed serially through the cooling devices. To adjust the performance of the cooling device(s) and/or the temperature at which the ammonia synthesis gas enters the first catalyst bed, a second part of the ammonia synthesis gas is, if necessary, guided in a bypass to at least one cooling device and mixed with the heated first part.

In order to achieve the variable temperature reduction of the partially reacted ammonia synthesis gas, which depends on the amount of provided make-up gas, the power of the cooling device(s) is specifically reduced in the second operating mode. For this purpose, at least a part of the ammonia synthesis gas provided for the reaction in the ammonia reactor is not conducted as a cooling agent through the cooling device(s) arranged between the catalyst beds for cooling partially reacted ammonia synthesis gas, but is guided in a bypass to the cooling device(s) in the first catalyst bed. Depending on the amount of make-up gas, the ratio of the cooling agent flow to the bypass flow is changed, wherein this ratio is all the smaller and the cooling capacity is consequently reduced all the more, the less make-up gas is provided. Due to the reduced cooling capacity, a reduced ammonia content is achieved at the outlet of the ammonia reactor, which means that the ammonia reactor can be operated at a pressure that is above a specified minimum pressure even with a greatly reduced amount of supplied make-up gas.

In order to ensure that the ammonia synthesis gas can be introduced into the first catalyst bed at a sufficiently high temperature, it is proposed to heat at least the amount of ammonia synthesis gas to be fed in the bypass against the synthesis product, for which purpose it is preferably guided through a heat exchanger arranged downstream of the last catalyst bed in order to indirectly exchange heat with the synthesis product. It is also possible to heat the entire ammonia synthesis gas against the synthesis product before the part intended for bypass routing is separated.

Preferably, the synthesis product, which in addition to ammonia also contains considerable amounts of hydrogen and nitrogen, is withdrawn hot from the ammonia reactor and cooled in several cooling stages in order to condense out ammonia and produce a two-phase mixture of substances which is separated in a separator into a liquid phase consisting predominantly of ammonia and a gas phase consisting largely of hydrogen and nitrogen and containing residues of unseparated ammonia. To increase the ammonia yield, the gas phase is returned to the ammonia reactor as recycle gas and mixed with the make-up gas consisting of hydrogen and nitrogen to form ammonia synthesis gas. If the ammonia reactor has to be operated at partial load due to a lack of make-up and the measures described above are not sufficient to avoid an excessive reduction in the reactor pressure, it is proposed to separate a partial stream of the synthesis product upstream of at least one of the several cooling stages and to feed it into the separator without further cooling, except for unavoidable line losses. This increases the ammonia concentration in the recycle gas and consequently also in the ammonia synthesis gas, which leads to a lower reaction and a reduced temperature rise in the first catalyst bed.

The method according to the invention can be used with particular advantage if the hydrogen and/or nitrogen required for the provision of the make-up gas is generated using electricity that is obtained directly from renewable sources such as wind or solar power plants, or as surplus electricity from the public grid.

Furthermore, the invention relates to an apparatus for the synthesis of ammonia, comprising a device with which a make-up gas can be provided for forming an ammonia synthesis gas, an ammonia reactor in which at least a first and a second catalyst bed connected to the first via a cooling device are arranged, via which the provided ammonia synthesis gas can be reacted into a synthesis product containing ammonia, a feed device via which ammonia synthesis gas can be fed to the first catalyst bed as feed and to the cooling device as cooling agent in order to lower the temperature of the ammonia synthesis gas partially reacted in the first catalyst bed before it is forwarded to the second catalyst bed, and a control device via which the extent of the temperature reduction can be adjusted depending on the provided amount of make-up gas.

The stated object is achieved according to the invention in terms of the apparatus in that the cooling device is designed as a heat exchanger in which ammonia synthesis gas used as a cooling agent can be warmed up in indirect heat exchange against partially reacted ammonia synthesis gas before its use in the first catalyst bed.

Preferably, the apparatus according to the invention comprises an AIC ammonia reactor which the above-mentioned comparative study confirms to be significantly more suitable for ammonia synthesis than an AQC reactor used in the prior art.

The ammonia reactor can be designed with more than two, preferably with three catalyst beds, each of which is serially connected to each other via a cooling device.

Particularly preferably, the apparatus according to the invention comprises a line via which at least a part of the provided ammonia synthesis gas can be supplied to the first catalyst bed in a bypass to the cooling device(s) arranged between the catalyst beds, wherein the size of the bypass flow can be adjusted via the control device.

Advantageously, a further cooling device is arranged downstream of the last catalyst bed in the flow direction, with which at least the partial flow of the provided ammonia synthesis gas guided in the bypass can be heated against the synthesis product to be cooled in indirect heat exchange. This cooling device is logically located within the jacket of the ammonia reactor so that external hot gas lines are avoided, and the ammonia synthesis gas entering the ammonia reactor can cool the jacket of the reactor.

In a development of the apparatus according to the invention, it is proposed to arrange several cooling devices and a separator in series downstream of the ammonia reactor in order to condense and separate ammonia from the synthesis product, which in addition to ammonia also contains considerable amounts of hydrogen and nitrogen, and to be able to obtain a liquid phase consisting predominantly of ammonia and a gas phase consisting largely of hydrogen and nitrogen and containing residues of ammonia that has not been condensed out, wherein the separator is connected to the ammonia reactor in such a way that the gas phase is returned to the ammonia reactor as recycle gas and is miscible with the make-up gas consisting of hydrogen and nitrogen to form the ammonia synthesis gas. The apparatus according to the invention may further comprise a bypass line via which, in the event of a lack of make-up gas, a partial flow of the synthesis product can be separated upstream of at least one of the plurality of cooling devices and can be fed into the separator without further cooling.

In a particularly preferred embodiment of the apparatus according to the invention, the device for providing the make-up gas is designed to generate hydrogen and/or nitrogen using electricity that is obtained directly from renewable sources such as wind or solar power plants, or as surplus electricity from the public grid. As a hydrogen generator, the device can, for example, have an electrolyzer with which water can be electrochemically decomposed into hydrogen and oxygen.

The invention enables the operation of ammonia synthesis at a very low partial load so that it can be carried out even with strongly fluctuating ammonia synthesis gas quantities without or with significantly smaller intermediate storage facilities for hydrogen and/or nitrogen compared to the prior art.

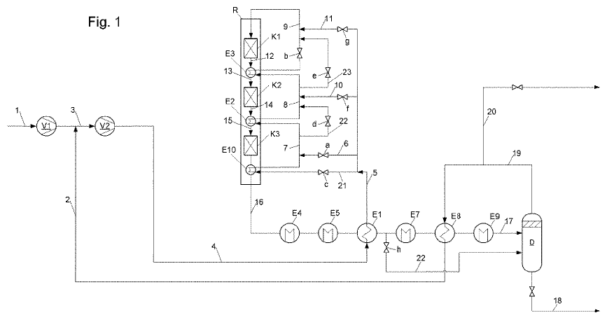

The invention is explained in more detail below using an exemplary embodiment schematically illustrated in FIG. 1.

FIG. 1 shows an ammonia synthesis which can be operated according to the invention with low partial load.

The pressure of the make-up gas 1 consisting of hydrogen and nitrogen, which is generated in a device not shown using electricity from renewable sources or surplus electricity with a fluctuating flow rate, is increased in the compressor V1 before it is combined with the hydrogen- and nitrogen-rich recycle gas 2 to form the ammonia synthesis gas 3. After a further pressure increase in the compressor V2, the ammonia synthesis gas 4 is preheated in the heat exchanger E1 against the synthesis product 16 to be cooled so that it is ready at a temperature between 100 and 250 °C, preferably between 140 and 200 °C, as preheated ammonia synthesis gas 5 for introduction into the ammonia reactor R designed as an AIC reactor.

If the flow rate of the make-up gas 1 is above a threshold value such as in particular during full load operation, the ammonia synthesis is operated in a first mode, with valves a and b open and valves c, d and e closed. At least the majority of the ammonia synthesis gas 5 formed using the make-up gas 1 is therefore fed to the first catalyst bed K1 via the lines 6, 7, 8 and 9 and is heated to a temperature of approximately 360 °C in the heat exchangers E2 and E3. Parts of the ammonia synthesis gas 5 can be guided in a bypass via lines 10 and 11 and valves f and g to the heat exchangers E2 and E3 in order to control their cooling capacity and thus the inlet temperature into the first catalyst bed K1. A part of the hydrogen and nitrogen contained in the ammonia synthesis gas 9 is reacted to ammonia in an exothermic reaction in the first catalyst bed K1 so that a first partially reacted ammonia synthesis gas 12 emerges from the first catalyst K1 at an elevated temperature and is indirectly cooled in the heat exchanger E3 against non-reacted ammonia synthesis gas 8. From the cooled first partially reacted ammonia synthesis gas 13, a second partially reacted ammonia synthesis gas 14 with an elevated temperature is obtained in the second catalyst bed K2 and is indirectly cooled in the heat exchanger E2 against non-reacted ammonia synthesis gas 7. In the third catalyst bed K3, the synthesis product 16 is obtained from the cooled second partially reacted ammonia synthesis gas 15 and is cooled stepwise in the heat exchangers E1 and E4 to E9, wherein a large part of the contained ammonia is condensed out, and a two-phase mixture 17 is formed. In the separator D, a liquid fraction 18 consisting largely of ammonia and a gas fraction 19 containing ammonia that has not been condensed out and non-reacted hydrogen and nitrogen are formed from the two-phase substance mixture 17 which, after a possible discharge of inert substances (such as argon) via the purge gas line 20 and heating against synthesis product 16 to be cooled, is returned as recycle gas 2 in front of the compressor V2.

If the make-up gas 1 is only available at a flow rate lying below the threshold value, the system is switched to a second operating mode. For this purpose, the valves c, d and e are opened so that at least a part 21 of the preheated ammonia synthesis gas 5 is guided via the heat exchanger E10 and the lines 22 and 23 in the bypass to the heat exchangers E2 and E3 before it enters the first catalyst bed K1 via line 9. At the same time, less or no ammonia synthesis gas is guided through the heat exchangers E2 and E3, the cooling capacities of which are therefore reduced compared to the operation of the plant described above with a flow rate lying above the threshold value. The temperatures of the partially reacted ammonia synthesis gases 12 and 14 are therefore reduced less or not at all in the heat exchangers E2 and E3 so that the first partially reacted ammonia synthesis gas 13 enters the catalyst bed K2 and the second partially reacted ammonia synthesis gas 15 enters the catalyst bed K3 at an increased temperature. Due to the increased inlet temperatures, the reaction in these catalyst beds is lower (in an extreme case, no reaction takes place) so that the gas temperatures here do not increase, or increase only slightly despite the lower volume flows.

Preferably, all valves a to g are designed as control valves so that the distribution of the preheated ammonia synthesis gas 9 to the heat exchangers E10, E2 and E3 can be adjusted via a control device (not shown) depending on the available quantity of the make-up gas 1. The adjustment is expediently made at least in the first operating mode in such a way that the overall reaction is maximum, and at the same time the temperature in each of the catalyst beds K1 to K3 does not exceed a specified limit value. Optionally, the adjustment in the second operating mode is made in such a way that the reaction is minimal, and at the same time the temperature in each of the catalyst beds K1 to K3 does not fall below a specified limit value. In the extreme case, valves a, b, f and g are closed, and no ammonia synthesis gas is conducted as a cooling agent through the heat exchangers E2 and E3, whereby the partially reacted gas streams 12 and 14 are not cooled. The total amount of preheated ammonia synthesis gas 5 is guided through the heat exchanger E10, wherein it reaches the temperature in indirect heat exchange with the synthesis product 16, at which it then enters the catalyst bed K1 via the line 9.

In order to be able to introduce the ammonia synthesis gas 9 into the catalyst bed at the required inlet temperature when the intermediate cooling in the heat exchangers E2 and E3 is partially or completely dispensed with, the temperature of the ammonia synthesis gas stream 5 entering the reactor R can be increased, for example by guiding part of the hot synthesis product in the bypass to the two heat exchangers E4 and E5 or at least to one of the two.

If the described measures are not sufficient to keep the pressure in or the flow rate of the ammonia synthesis gas through the ammonia reactor R above a certain threshold value and at the same time the temperature of the ammonia reactor R below a limit value, an ammonia-rich stream 22 can be conducted directly into the separator D by opening the bypass valve h, while bypassing the heat exchangers E7, E8 and E9. This increases the ammonia partial pressure in the gas fraction 18 and in the ammonia synthesis gas 9, which reduces the reaction and the temperature in the reactor R.

1. A method for the synthesis of ammonia, in which a gas mixture (make-up gas) comprising hydrogen and nitrogen is provided in a first operating mode with a flow rate lying above a threshold value and in a second operating mode with a flow rate lying below this threshold value in order to form an ammonia synthesis gas which is reacted in an ammonia reactor in at least one first catalyst bed and in a second catalyst bed, connected to the first catalyst bed, to form a synthesis product containing ammonia, wherein in a cooling device arranged between the first catalyst bed and the second catalyst bed, non-reacted ammonia synthesis gas is used as a cooling agent in order to reduce the temperature of an ammonia synthesis gas partially reacted in the first catalyst bed before it is forwarded to the second catalyst bed, wherein in the second operating mode, the higher the flow rate of the provided make-up gas, the greater the reduction in temperature of the partially reacted ammonia synthesis gas, wherein the cooling of the ammonia synthesis gas partially reacted in the first catalyst bed is carried out in indirect heat exchange against provided ammonia synthesis gas.

2. The method according to claim 1, wherein the provided ammonia synthesis gas is reacted in the ammonia reactor in more than two catalyst beds passed through in series to form the synthesis product, wherein a cooling device is arranged between each two immediately adjacent catalyst beds, in which provided ammonia synthesis gas serves as a cooling agent in order to cool the ammonia synthesis gas partially reacted in one catalyst bed in indirect heat exchange before it is forwarded to the following catalyst bed.

3. The method according to claim 1, wherein at least a part of the provided ammonia synthesis gas is fed to the first catalyst bed in the second operating mode in the bypass to the cooling device(s).

4. The method according to claim 3, wherein at least a partial stream of the provided ammonia synthesis gas is heated against the synthesis product.

5. The method according to claim 4, wherein, depending on the amount of provided make-up gas, the ratio of the part of the ammonia synthesis gas used as cooling agent in the cooling device(s) to the part guided in the bypass to the cooling device(s) is changed, wherein this ratio is all the smaller, the less make-up gas is provided.

6. The method according to claim 1, wherein the synthesis product is withdrawn from the ammonia reactor and cooled in several cooling stages in order to condense out ammonia and produce a two-phase mixture of substances which is separated in a separator into a liquid phase consisting predominantly of ammonia and a gas phase consisting largely of hydrogen and nitrogen and containing residues of ammonia that has not been condensed out, wherein the gas phase is returned to the ammonia reactor as recycle gas and is mixed with the make-up gas consisting of hydrogen and nitrogen to form the ammonia synthesis gas.

7. The method according to claim 6, wherein in the second operating mode, a partial stream of the synthesis product is separated upstream of at least one of the plurality of cooling stages and is fed into the separator without further cooling.

8. The method according to claim 1, wherein hydrogen and/or nitrogen required for the provision of the make-up gas is generated using electricity which is obtained directly from renewable sources such as wind or solar power plants, or as surplus electricity from the public grid.

9. An apparatus for the synthesis of ammonia, comprising a device with which a make-up gas for forming an ammonia synthesis gas can be provided, an ammonia reactor in which at least a first catalyst bed and a second catalyst bed connected to the first via a cooling device are arranged, via which the provided ammonia synthesis gas can be reacted to form a synthesis product containing ammonia, a feed device via which ammonia synthesis gas can be fed to the first catalyst bed as feed and to the cooling device as a cooling agent in order to lower the temperature of the ammonia synthesis gas partially reacted in the first catalyst bed before it is forwarded to the second catalyst bed, and a control device via which the extent of the temperature reduction can be adjusted as a function of the amount of provided make-up gas, wherein the cooling device is designed as a heat exchanger in which ammonia synthesis gas used as cooling agent can be warmed up in indirect heat exchange against partially reacted ammonia synthesis gas before being fed in the first catalyst bed.

10. The apparatus according to claim 9, wherein in the ammonia reactor is designed with more than two, preferably with three catalyst beds which are each connected to one another in series via a cooling device.

11. The apparatus according to claim 9, wherein it has a line via which at least a part of the provided ammonia synthesis gas can be fed to the first catalyst bed in a bypass to the cooling device(s) arranged between the catalyst beds, wherein the size of the bypass flow can be adjusted via the control device.

12. The apparatus according to claim 11, wherein a cooling device is arranged downstream of the last catalyst bed in the flow direction, with which at least the partial flow of the provided ammonia synthesis gas, which is to be guided in the bypass, can be heated against the synthesis product to be cooled in indirect heat exchange.

13. The apparatus according to claim 12, wherein the cooling device arranged downstream of the last catalyst bed in the flow direction is located within the jacket of the ammonia reactor.

14. The apparatus according to claim 9, wherein downstream of the ammonia reactor, a plurality of cooling devices and a separator are arranged in series, via which ammonia can be condensed out and separated from the synthesis product which, in addition to ammonia, also contains hydrogen and nitrogen components, and a liquid phase consisting predominantly of ammonia, and a gas phase consisting largely of hydrogen and nitrogen and containing residues of ammonia that has not been condensed out can be obtained, wherein the separator is connected to the ammonia reactor in such a way that the gas phase can be returned to the ammonia reactor as recycle gas and can be mixed with the make-up gas consisting of hydrogen and nitrogen to form the ammonia synthesis gas.

15. The apparatus according to claim 9, wherein it comprises a device for generating hydrogen and nitrogen for providing the ammonia synthesis gas, in which hydrogen and/or nitrogen can be generated using electricity which is obtained directly from renewable sources such as wind or solar power plants, or as surplus electricity from the public grid.
